(19) United States
(12) Patent Application Publication
(10) Pub. No.: US 2024/0105968 A1
(43) Pub. Date: Mar. 28, 2024

(54) FUEL CELL ASSEMBLIES WITH FUEL CELL PLATES WITH REDUCED AND/OR ELIMINATED TRANSITION REGIONS

(71) Applicant: Loop Energy Inc., Burnaby (CA)

(72) Inventors: David Erwin Kadylak, Surrey (CA); Claudette Kennette, North Vancouver (CA); Matthew Paone, Burnaby (CA)

(21) Appl. No.: 18/480,788

(22) Filed: Oct. 4, 2023

Related U.S. Application Data
(63) Continuation of application No. PCT/CA2022/050549, filed on Apr. 8, 2022.
(60) Provisional application No. 63/173,424, filed on Apr. 10, 2021.

(51) Int. Cl. H01M 8/0265; H01M 8/04082; H01M 8/2475; H01M 8/248

(52) U.S. Cl. CPC H01M 8/0265; H01M 8/04201; H01M 8/2475; H01M 8/248

(57) ABSTRACT

In some embodiments, fuel cell assemblies can include fuel cell flow field plates with reduced, if not eliminated, transition regions. In some embodiments, methods and apparatus can reduce, if not eliminate, the area occupied by transition regions on a fuel cell plate in a fuel cell assembly. In some embodiments, the fuel cell stacks can include an oxidant inlet assembly including a sculpted oxidant inlet connector, and a feed-plate with a sculpted opening. In some embodiments, the fuel cell stacks can include an oxidant outlet assembly including a feed-plate with a sculpted opening, and a sculpted oxidant outlet connector.

### CROSS-REFERENCE TO RELATED APPLICATION(S)

This application is a continuation of International Application PCT/CA2022/050549 having a filing date of Apr. 8, 2022, entitled “Fuel Cell Assemblies with Fuel Cell Plates with Reduced and/or Eliminated Transition Regions”. The '549 application and this application are related to and claim priority benefits from U.S. Provisional Patent Application Ser. No. 63/173,424 having a filing date of Apr. 10, 2021, entitled “Fuel Cell Assemblies with Fuel Cell Plates with Reduced and/or Eliminated Transition Regions”. The '549 and '424 applications are hereby incorporated by reference herein in their entireties.

### FIELD OF THE INVENTION

The present disclosure relates to fuel cell assemblies comprising fuel cell flow field plates with reduced, if not eliminated, transition regions. The present disclosure also relates to methods and apparatus for reducing, if not eliminating, the area occupied by transition regions on a fuel cell plate in a fuel cell assembly. The present disclosure also relates to inlet and outlet assemblies for fuel cell stacks, the inlet and outlet assemblies including sculpted connectors and/or feed-plates with sculpted ports or openings therein.

Solid polymer fuel cells are electrochemical devices that produce electrical power and water from a fuel, such as hydrogen and oxygen. An individual solid polymer fuel cell comprises an ion exchange membrane electrolyte separating an anode and a cathode, the anode and cathode each comprising a catalyst layer. The anode-electrolyte-cathode is typically interposed between a pair of electrically conductive reactant flow field plates that facilitate the access of the fuel and oxidant to the anode and cathode catalyst layer, respectively, and provide for the removal of water formed during the operation of the fuel cell. In addition to facilitating distribution of reactants to the fuel cell electrodes, and removal of water produced from individual cells in a stack, the flow field plates can also assist with thermal management (cooling) and electrical current collection.

Flow field plates generally have a flow field on one or both of their major surfaces. The flow field often comprises one or more open-faced channels, for example, there can be reactant (fuel or oxidant) channels on one major surface of the plate and coolant channels on the other, or fuel channels on one major surface of the plate and oxidant channels on the other. The channels typically extend between an inlet and an outlet, although other arrangements, such as interdigitated channels or grid channel patterns are sometimes used. Typically, a porous, compressible fluid distribution layer, referred to herein as a gas diffusion layer (GDL), is interposed between the flow field plate and the respective electrode, and the reactants access the catalyst layer from the channels in the plates via the porous GDL. The membrane, anode and cathode catalyst layers and a pair of GDLs are often combined to form a membrane electrode assembly (MEA) which is then placed between a pair of flow field plates to form an individual fuel cell assembly. In other examples, a flow field can be an open chamber formed on one surface of the flow field plate, and the chamber can contain a porous material (such as a foam or mesh) through which a reactant can flow, and/or can include features to support the adjacent MEA. A plurality of fuel cell assemblies can be arranged to form a fuel cell stack. The active area of a fuel cell can be defined as the region in which (or area over which) the fuel cell electrochemical reaction takes place during operation of the fuel cell to produce electrical power and water from a fuel and oxidant. Generally, the active area is the region(s) of the fuel cell where the electrocatalyst is accessible to the gaseous reactants provided via the flow field, and where current can be collected. In some embodiments the area occupied by the flow field is the same as the active area, and they are co-extensive. In some embodiments the flow field extends beyond the active area, and the area occupied by the flow field is greater than the active area. The non-active area is generally the region(s) where there is no electrochemical activity occurring that contributes to the fundamental fuel cell reaction. The non-active area is typically located around the periphery of the fuel cell active area.

In conventional fuel cell flow field plates, within the active area the reactant channels typically have a constant width (and cross-sectional area) along their length. This is generally the case for fuel cells with straight channels and also for fuel cells having serpentine channels.

Conventional straight channel fuel cells where the fuel and oxidant are flowing in substantially the same direction across the fuel cell (referred to as a “co-flow” configuration of fuel and oxidant) often have localized high current density near the inlet where the pressures and reactant concentrations are highest. The heat generated in this region can require enhanced cooling to be provided in this region, often resulting in a unit cell design which has the inlet coolant port located at or near the start of the reactant channels.

Such an arrangement can result in the oxidant inlet port in the cathode flow field plate being offset from the main flow direction, and/or positioned at some distance from the start of the oxidant channels. In some cases, the oxidant inlet port is dimensionally unmatched (e.g. narrower) relative to the width of the active area or flow field it is feeding into. This offset, distance and/or dimensional mismatch often drives the need for intricately designed inlet transition regions to be provided on the flow field plate between the oxidant inlet port and the start of the oxidant channels. Similarly, on the fuel side, often an inlet transition region is provided on the anode flow field plate between the fuel inlet port and the start of the fuel channels. These inlet transition regions generally increase in width in the flow direction and are generally designed with flow-directing features and spaces that provide more uniform distribution of reactant among the downstream channels, for example, by reducing fluid momentum through expansion, and by redirection of fluids. Often, transition regions are provided not only at the reactant inlets but also at the reactant outlets of the fuel cell, for example, on the cathode flow field plate between the end of the oxidant channels and the oxidant outlet port and/or on the anode flow field plate between the end of the fuel channels and the fuel outlet port. Outlet transition regions typically decrease in width in the flow direction, and are generally designed with flow-directing features and spaces that facilitate collection and directing fluid from the channels to an outlet port.

Non-uniform flow distribution within a unit cell describes the incidence when more flow is distributed in certain channels compared to other channels in the same plate. Fuel cell performance is generally more sensitive to non-uniform channel-to-channel flow distribution at the cathode than at the anode, and effort is often put into designing cathode inlet transition regions to ensure that the flow rate in each of the oxidant channels is within a certain percentage of the mean. Non-uniform flow distribution at the cathode and/or the anode can lead to non-uniform current density distribution which, in turn, can lead to lower overall fuel cell performance and/or accelerated degradation mechanisms.

The area occupied by transition regions is often significant when compared to the overall active area of the flow field plates in a fuel cell. This can have a substantial adverse impact on the overall power density of a fuel cell stack.

In addition, by the nature of their designs, transition regions generally result in a reduction in the momentum of the oxidant flow and cause both a pressure drop and a reduction in flow velocities upstream of the reactant channels. Also, in cases where the transition region is within the active area, the flow directions of the fuel, oxidant and coolant streams are generally not aligned, and the temperature, pressure, and concentration gradients are not as high out-of-plane as they would be if the flows were aligned (in a co-flow configuration, for example). There is the added challenge of ensuring uniform, or at least near-uniform, flow distribution within and from a transition region at varying operational flow rates, where the momentum and viscosity effects differ. Another disadvantage of the use of transition regions, particularly at the oxidant outlet, is the reduced capacity of the fluid flow in these transition regions to effectively remove water. Transition regions are usually regions where channel geometry is broken up in the primary direction of flow, and there is less likely to be a build-up of pressure behind accumulations of liquid water that can drive the liquid water downstream.

Finally, because transition regions are generally designed or optimized for specific operational conditions (e.g. flow rate, pressure), different transition region designs may be required or be beneficial for different operational conditions. Fuel cell flow field plates are typically manufactured through compression molding or stamping that require costly hard tooling, making the plate design less flexible to operational changes.

Improved fuels cells, such as those described in U.S. Pat. Nos. 7,838,769 and 10,686,199 can have flow field plates with reactant channels having cross-sectional areas that vary along at least a portion of the channel length between an inlet and an outlet. Fuel cells that incorporate reactant channels with varying cross-sectional areas can provide several advantages over traditional fuel cell flow fields including, for example, providing more uniform current density, enhancing performance by increasing overall current density, and/or improved water management and reactant availability across the active area. In some fuel cells having flow field plates with reactant channels having cross-sectional areas that vary along at least a portion of the channel length between the inlet and the outlet, it is the channel width that varies.

The use of these improved flow fields plates (with oxidant and/or fuel channels having cross-sectional areas that vary along at least a portion of the channel length between an inlet and an outlet) can allow for a reduction in the area occupied by transition regions, or elimination of transition regions, on a fuel cell flow field plate in a fuel cell assembly.

### SUMMARY OF THE INVENTION

In some embodiments, a fuel cell assembly can include a first flow field plate, a second flow field plate, a membrane electrode assembly between the first flow field plate and the second flow field plate.

In some embodiments, the first flow field plate can include a first inlet port; a second inlet port; a first outlet port; and/or a second outlet port.

In some embodiments, the second flow field plate can include a corresponding first inlet port; a corresponding second inlet port; a corresponding first outlet port; and a corresponding second outlet port.

In some embodiments, the first inlet port and the corresponding first inlet port align to form at least a portion of a first inlet header, the second inlet port and the corresponding second inlet port align to form at least a portion of a second inlet header, the first outlet port and the corresponding first outlet port align to form at least a portion of a first outlet header, the second outlet port and the corresponding second outlet port align to form at least a portion of a second outlet header, the first inlet port is fluidly connected to the first outlet port via a first flow field, and the second inlet port is fluidly connected to the second outlet port via a second flow field.

In some embodiments, the first flow field comprises a first plurality of channels, each channel of the first plurality of channels having a channel inlet and a channel outlet. In some embodiments, the channel inlets of the first plurality of channels are fluidly connected to the first inlet port via a first inlet transition region, and the channel outlets of the first plurality of channels are fluidly connected to the first outlet port via a first outlet transition region.

In some embodiments, the combined area of the first inlet transition region and the first outlet transition region is less than 150% of the combined area of the first inlet port and the first outlet port. In some embodiments, the first flow field occupies a first flow field area, and the combined area of the first inlet transition region and the first outlet transition region is less than 20% of the first flow field area. In some embodiments, the first flow field occupies a first flow field area, and the combined area of the first inlet transition region and the first outlet transition region is less than 5% of the first flow field area.

In some embodiments, a cross-sectional flow area in the first inlet transition region is substantially constant between the first inlet port and the channel inlets of the first plurality of channels. In some embodiments, a cross-sectional flow area in the first outlet transition region is substantially constant between the channel outlets of the first plurality of channels and the first outlet port.

In some embodiments, the second flow field comprises a second plurality of channels, each channel of the second plurality of channels having a channel inlet and a channel outlet, the channel inlets of the second plurality of channels are fluidly connected to the second inlet port via a second inlet transition region, and the channel outlets of the second plurality of channels are fluidly connected to the second outlet port via a second outlet transition region.

In some embodiments, the combined area of the first inlet transition region, the first outlet transition region, the second inlet transition region and the second outlet transition region is less than 150% of the combined area of the first inlet port, the first outlet port, the second inlet port and the second outlet port.

In some embodiments, the first flow field occupies a first flow field area, and the combined area of the first inlet transition region, the first outlet transition region, the second inlet transition region and the second outlet transition region is less than 20% of the first flow field area. In some embodiments, the first flow field occupies a first flow field area, and the combined area of the first inlet transition region, the first outlet transition region, the second inlet transition region and the second outlet transition region is less than 5% of the first flow field area.

In some embodiments, the first flow field comprises a first plurality of channels, each channel of the first plurality of channels having a channel inlet and a channel outlet, and the channel inlets of the first plurality of channels are located at the first inlet port and/or the channel outlets of the first plurality of channels are located at the first outlet port.

In some embodiments, the second flow field comprises a second plurality of channels, each channel of the second plurality of channels having a channel inlet and a channel outlet, and the channel inlets of the second plurality of channels are located at the second inlet port and/or the channel outlets of the second plurality of channels are located at the second outlet port.

In some embodiments, the first flow field plate can further include
a third inlet port and a third outlet port. In some embodiments, the second flow field plate can further include a corresponding third inlet port and a corresponding third outlet port. In some embodiments, the third inlet port and the corresponding third inlet port align to form at least a portion of a third inlet header. In some embodiments, the third outlet port and the corresponding third outlet port align to form at least a portion of a third outlet header. In some embodiments, the third inlet port is fluidly connected to the third outlet port via a third flow field.

In some embodiments, the first flow field comprises a first plurality of channels, each channel of the first plurality of channels having a channel inlet and a channel outlet. In some embodiments, the second flow field comprises a second plurality of channels, each channel of the second plurality of channels having a channel inlet and a channel outlet. In some embodiments, the third flow field comprises a third plurality of channels, each channel of the third plurality of channels having a channel inlet and a channel outlet.

In some embodiments, the channel inlets of the first plurality of channels are fluidly connected to the first inlet port via a first inlet transition region, the channel outlets of the first plurality of channels are fluidly connected to the first outlet port via a first outlet transition region, the channel inlets of the second plurality of channels are fluidly connected to the second inlet port via a second inlet transition region, the channel outlets of the second plurality of channels are fluidly connected to the second outlet port via a second outlet transition region, the channel inlets of the third plurality of channels are fluidly connected to the third inlet port via a third inlet transition region, and/or the channel outlets of the third plurality of channels are fluidly connected to the third outlet port via a third outlet transition region.

In some embodiments, the combined area of the first inlet transition region, the first outlet transition region, the second inlet transition region, the second outlet transition region, the third inlet transition region and the third outlet transition region is less than 150% of the combined area of the first inlet port, the first outlet port, the second inlet port, the second outlet port, the third inlet port and the third outlet port.

In some embodiments, the first flow field occupies a first flow field area, and the combined area of the first inlet transition region, the first outlet transition region, the second inlet transition region, the second outlet transition region, the third inlet transition region and the third outlet transition region is less than 20% of the first flow field area. In some embodiments, the first flow field occupies a first flow field area, and the combined area of the first inlet transition region, the first outlet transition region, the second inlet transition region, the second outlet transition region, the third inlet transition region and the third outlet transition region is less than 5% of the first flow field area.

In some embodiments, the channel inlets of the first plurality of channels are located at the first inlet port, and the channel outlets of the first plurality of channels are located at the first outlet port, the channel inlets of the second plurality of channels are located at the second inlet port, and the channel outlets of the second plurality of channels are located at the second outlet port, and/or the channel inlets of the third plurality of channels are located at the third inlet port, and the channel outlets of the second plurality of channels are located at the third outlet port.

In some embodiments, the first inlet port has a first inlet port width and, at the channel inlets of the first plurality of channels, the first plurality of channels span a first inlet flow field width, and the first outlet port has a first outlet port width and, at the channel outlets of the first plurality of channels, the first plurality of channels span a first outlet flow field width.

In some embodiments, the first inlet flow field width is substantially the same as the first inlet port width. In some embodiments, the first outlet flow field width is substantially the same as the first outlet port width. In some embodiments, the first inlet port width and the first inlet flow field width differ by no more than 25% of the first inlet flow field width. In some embodiments, the first outlet port width and the first outlet flow field width differ by no more than 25% of the first outlet flow field width.

In some embodiments, the first inlet port, the first outlet port and the first flow field are configured to carry an oxidant. In some embodiments, the second inlet port, the second outlet port and the second flow field are configured to carry a fuel.

In some embodiments, the fuel cell assembly has an active area that is trapezoidal. In some embodiments, the first flow field plate and the second flow field plate are trapezoidal.

In some embodiments, some or all of the channels of the first plurality of channels decreases in cross-sectional area along at least a portion of the channel length from the channel inlet to the channel outlet. In some embodiments, some or all of the channels of the first plurality of channels decreases monotonically in cross-sectional area from the channel inlet to the channel outlet. In some embodiments, some or all of the channels of the first plurality of channels decreases linearly in cross-sectional area along at least a portion of the channel length from the channel inlet to the channel outlet. In some embodiments, some or all of the channels of the first plurality of channels decreases exponentially in cross-sectional area along at least a portion of the channel length from the channel inlet to the channel outlet.

In some embodiments, during operation of the fuel cell assembly, the first inlet header is supplied with a first reactant, and the flow rate of the first reactant through each channel of the first plurality of channels is within ±20% of the average flow rate of the first reactant among the first plurality of channels. In some embodiments, during operation of the fuel cell assembly, the first inlet header is supplied with a first reactant, and the flow rate of the first reactant through each channel of the first plurality of channels is within ±15% of the average flow rate of the first reactant among the first plurality of channels. In some embodiments, during operation of the fuel cell assembly, the first inlet header is supplied with a first reactant, and the flow rate of the first reactant through each channel of the first plurality of channels is within ±10% of the average flow rate of the first reactant among the first plurality of channels. In some embodiments, during operation of the fuel cell assembly, the first inlet header is supplied with a first reactant, and the flow rate of the first reactant through each channel of the first plurality of channels is within ±2.5% of the average flow rate of the first reactant among the first plurality of channels.

In some embodiments, during operation of the fuel cell assembly, the first inlet header is supplied with a first reactant, and the flow rate of the first reactant through each channel of the first plurality of channels is substantially the same.

In some embodiments, during operation of the fuel cell assembly, the first inlet header is supplied with a first reactant, and the pressure in each of the first plurality of channels is within ±20% of the average pressure among the first plurality of channels. In some embodiments, during operation of the fuel cell assembly, the first inlet header is supplied with a first reactant, and the pressure in each of the first plurality of channels is within ±15% of the average pressure among the first plurality of channels. In some embodiments, during operation of the fuel cell assembly, the first inlet header is supplied with a first reactant, and the pressure in each of the first plurality of channels is within ±10% of the average pressure among the first plurality of channels. In some embodiments, during operation of the fuel cell assembly, the first inlet header is supplied with a first reactant, and the pressure in each of the first plurality of channels is within ±1% of the average pressure among the first plurality of channels.

In some embodiments, during operation of the fuel cell assembly, the first inlet header is supplied with a first reactant, and the pressure in each of the first plurality of channels is substantially the same.

In some embodiments, the first inlet port, the first outlet port and the first flow field are configured to carry an oxidant, the second inlet port, the second outlet port and the second flow field are configured to carry a fuel, and/or the third inlet port, the third outlet port and the third flow field are configured to carry a coolant.

In some embodiments, the third plurality of channels follows a Z-type flow configuration.

In some embodiments, a fuel cell stack includes a fuel cell assembly (such as one of the embodiments recited above), a first end-plate assembly; and a second end-plate assembly.

In some embodiments, the fuel cell stack further includes disc springs, tie-rods, hydraulic systems, clamps, straps configured to urge the first end-plate assembly and the second end-plate assembly toward each other, and/or a sculpted first inlet connector fluidly connected to the first inlet header. In some embodiments, the sculpted first inlet connector acts as a transition region.

In some embodiments, of the fuel cell stack the first flow field includes a first plurality of channels, each channel of the first plurality of channels having a channel inlet and a channel outlet, and the channel inlets of the first plurality of channels are located at the first inlet port.

In some embodiments, a method of operating a fuel cell assembly (such as one of the embodiments recited above) involves supplying a first reactant to the first inlet header so that the first reactant flows from the first inlet port to the first outlet port via the first flow field in a first direction, supplying a second reactant to the second inlet header so that the second reactant flows from the second inlet port to the second outlet port via the second flow field in a second direction. In some embodiments, the first direction and the second direction are substantially the same, whereby the fuel cell assembly is operated in a co-flow reactant configuration.

In some embodiments of a method of operating a fuel cell assembly (such as one of the embodiments recited above), an oxidant is supplied to the first inlet header and flows from the first inlet port to the first outlet port via the first flow field in a first direction, a fuel is supplied to the second inlet header and flows from the second inlet port to the second outlet port via the second flow field in a second direction, a coolant is supplied to the third inlet header and flows from the third inlet port to the third outlet port via the third flow field in a third direction. In some embodiments the first direction, the second direction and the third direction are substantially the same, whereby the fuel cell assembly is operated in a co-flow reactant and coolant configuration.

In some embodiments with a co-flow reactant configuration or a co-flow reactant and coolant configuration, a first reactant is supplied to the first inlet header and flows from the first inlet port to the first outlet port via the first flow field, and a flow rate of the first reactant through each channel of the first plurality of channels is substantially the same.

In some embodiments with a co-flow reactant configuration or a co-flow reactant and coolant configuration, a first reactant is supplied to the first inlet header and flows from the first inlet port to the first outlet port via the first flow field, and the flow rate of the first reactant through each channel of the first plurality of channels is within ±20% of the average flow rate of the first reactant among the first plurality of channels. In some embodiments with a co-flow reactant configuration or a co-flow reactant and coolant configuration, a first reactant is supplied to the first inlet header and flows from the first inlet port to the first outlet port via the first flow field, and the flow rate of the first reactant through each channel of the first plurality of channels is within ±15% of the average flow rate of the first reactant among the first plurality of channels. In some embodiments with a co-flow reactant configuration or a co-flow reactant and coolant configuration, a first reactant is supplied to the first inlet header and flows from the first inlet port to the first outlet port via the first flow field, and the flow rate of the first reactant through each channel of the first plurality of channels is within ±10% of the average flow rate of the first reactant among the first plurality of channels. In some embodiments with a co-flow reactant configuration or a co-flow reactant and coolant configuration, a first reactant is supplied to the first inlet header and flows from the first inlet port to the first outlet port via the first flow field, and the flow rate of the first reactant through each channel of the first plurality of channels is within ±2.5% of the average flow rate of the first reactant among the first plurality of channels.

In some embodiments with a co-flow reactant configuration or a co-flow reactant and coolant configuration, a first reactant is supplied to the first inlet header and flows from the first inlet port to the first outlet port via the first flow field, and the pressure in each of the first plurality of channels substantially the same.

In some embodiments with a co-flow reactant configuration or a co-flow reactant and coolant configuration, a first reactant is supplied to the first inlet header and flows from the first inlet port to the first outlet port via the first flow field, and the pressure in each of the first plurality of channels is within ±20% of the average pressure among the first plurality of channels. In some embodiments with a co-flow reactant configuration or a co-flow reactant and coolant configuration, a first reactant is supplied to the first inlet header and flows from the first inlet port to the first outlet port via the first flow field, and the pressure in each of the first plurality of channels is within ±15% of the average pressure among the first plurality of channels. In some embodiments with a co-flow reactant configuration or a co-flow reactant and coolant configuration, a first reactant is supplied to the first inlet header and flows from the first inlet port to the first outlet port via the first flow field, and the pressure in each of the first plurality of channels is within ±10% of the average pressure among the first plurality of channels. In some embodiments with a co-flow reactant configuration or a co-flow reactant and coolant configuration, a first reactant is supplied to the first inlet header and flows from the first inlet port to the first outlet port via the first flow field, and the pressure in each of the first plurality of channels is within ±1% of the average pressure among the first plurality of channels.

In some embodiments, a first reactant is supplied to the first inlet header and flows from the first inlet port to the first outlet port via the first flow field, and the velocity of the first reactant at the inlets of the first plurality of channels and the velocity of the first reactant at the first inlet port differs by no more than 30%.

In some embodiments, a first reactant is supplied to the first inlet header and flows from the first inlet port to the first outlet port via the first flow field, and the velocity of the first reactant at the outlets of the first plurality of channels is at least 40% greater than the velocity of the first reactant at the inlets of the first plurality of channels.

In some embodiments, a fuel cell flow field plate can include a first inlet port; a second inlet port; a first outlet port; a second outlet port; a first major surface; and a second major surface. In some embodiments, the first inlet port is fluidly connected to the first outlet port via a first flow field on the first major surface of the flow field plate. In some embodiments, the second inlet port is fluidly connected to the second outlet port via a second flow field formed on the second major surface of the flow field plate.

In some embodiments, the first flow field comprises a first plurality of channels, each channel of the first plurality of channels having a channel inlet and a channel outlet.

In some embodiments, the channel inlets of the first plurality of channels are fluidly connected to the first inlet port via a first inlet transition region, and/or the channel outlets of the first plurality of channels are fluidly connected to the first outlet port via a first outlet transition region.

In some embodiments, the combined area of the first inlet transition region and the first outlet transition region is less than 150% of the combined area of the first inlet port and the first outlet port. In some embodiments, the combined area of the first inlet transition region and the first outlet transition region is less than 20% of the area occupied by the first flow field.

In some embodiments of a fuel cell flow field plate, a cross-sectional flow area in the first inlet transition region is substantially constant between the first inlet port and the channel inlets of the first plurality of channels, and a cross-sectional flow area in the first outlet transition region is substantially constant between the channel outlets of the first plurality of channels and the first outlet port.

In some embodiments of a fuel cell flow field plate, the second flow field comprises a second plurality of channels, each channel of the second plurality of channels having a channel inlet and a channel outlet, the channel inlets of the second plurality of channels are fluidly connected to the second inlet port via a second inlet transition region, and/or the channel outlets of the second plurality of channels are fluidly connected to the second outlet port via a second outlet transition region.

In some embodiments, the combined area of the first inlet transition region, the first outlet transition region, the second inlet transition region and the second outlet transition region is less than 150% of the combined area of the first inlet port, the first outlet port, the second inlet port and the second outlet port. In some embodiments, the combined area of the first inlet transition region, the first outlet transition region, the second inlet transition region and the second outlet transition region is less than 20% of the area occupied by the first flow field.

In some embodiments, the first flow field comprises a first plurality of channels, each channel of the first plurality of channels having a channel inlet and a channel outlet, and the channel inlets of the first plurality of channels are located at the first inlet port and/or the channel outlets of the first plurality of channels are located at the first outlet port.

In some embodiments, the second flow field comprises a second plurality of channels, each channel of the second plurality of channels having a channel inlet and a channel outlet, and the channel inlets of the second plurality of channels are located at the second inlet port and/or the channel outlets of the second plurality of channels are located at the second outlet port.

In some embodiments, the first inlet port has a first inlet port width and, at the channel inlets of the first plurality of channels, the first plurality of channels span a first inlet flow field width, and/or the first outlet port has a first outlet port width and, at the channel outlets of the first plurality of channels, the first plurality of channels span a first outlet flow field width.

In some embodiments, the first inlet flow field width is substantially the same as the first inlet port width. In some embodiments, the first outlet flow field width is substantially the same as the first outlet port width.

In some embodiments, the first inlet port width and the first inlet flow field width differ by no more than 25% of the first inlet flow field width. In some embodiments, the first outlet port width and the first outlet flow field width differ by no more than 25% of the first outlet flow field width.

### BRIEF DESCRIPTION OF THE DRAWINGS

FIG. 1 is a perspective view of a fuel cell stack with some of the fuel cell assemblies removed for clarity.

FIG. 2 is an exploded cross-sectional view of a fuel cell assembly.

FIG. 3 is a plan view of a flow field plate with inlet and outlet transition regions between the respective inlet and outlet ports and the channels.

FIGS. 4A-C are plan views of one major surface (the cathode-facing side) of a trapezoidal fuel cell flow field plate.

FIG. 5A is a perspective view of a fuel cell stack with sculpted inlet and outlet connectors.

FIG. 5B is an exploded perspective view of the fuel cell stack of FIG. 5B.

FIG. 6 is a plot showing the oxidant mass flow rate in each of a plurality of channels in a cathode flow field, determined at the same distance down the length of each channel, based on Computational Fluid Dynamics (CFD) modelling for a flow field plate similar to that shown in FIGS. 4A-4C.

FIG. 7 is a plot showing the oxidant pressure in each of a plurality of cathode channels in a cathode flow field, determined at the same distance down the length of each channel, based on CFD modelling for a flow field plate similar to that shown in FIGS. 4A-4C.

FIG. 8 is a plot showing the fuel mass flow rate in each of a plurality of channels in an anode flow field, determined at the same distance down the length of each channel based on CFD modelling for a flow field plate.

FIG. 9 is a plot showing the fuel pressure profile in each of a plurality of anode channels in an anode flow field, determined at the same distance down the length of the each channel based on CFD modelling for a flow field plate.

FIG. 10 shows a top view of the flow velocity of a fluid flowing from inlet ports through headers in a fuel cell stack, based on CFD modelling, the fluid supplied via a sculpted connector and feed-plate.

FIG. 11 is a cross-sectional view of an oxidant inlet connector and feed-plate for a fuel cell stack.

FIG. 12 is a top cross-sectional view of an oxidant outlet connector and feed-plate for a fuel cell stack.

### DETAILED DESCRIPTION OF ILLUSTRATIVE EMBODIMENT(S)

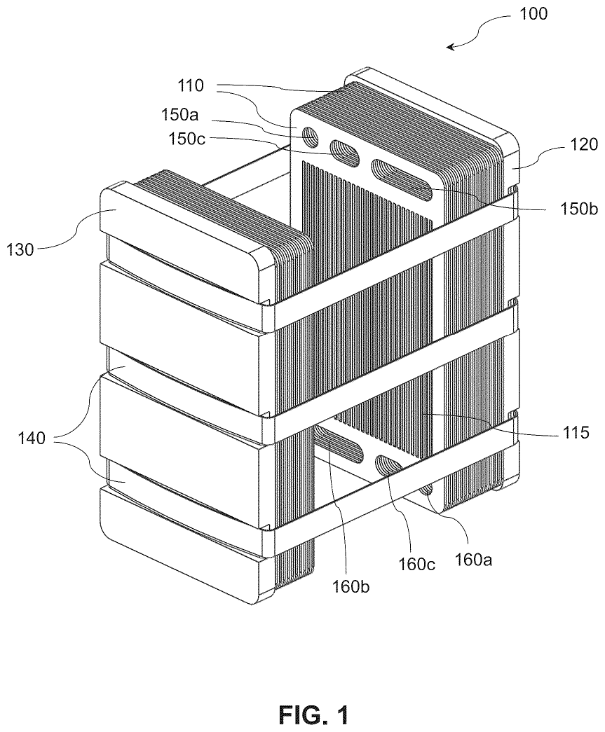

FIG. 1 shows fuel cell stack 100 comprising a plurality of individual fuel cell assemblies 110 stacked between end-plate assemblies 120 and 130. In some embodiments, disc spring(s) (not visible in FIG. 1) and straps 140 are used to hold end-plate assemblies 120 and 130 in position and to urge them toward one another to apply compressive force on plurality of fuel cell assemblies 110 interposed between them. In some embodiments, other types of compression systems can be used in fuel cell stacks such as, but not limited to, tie-rods, hydraulic systems, and/or clamps.

In some embodiments, end-plate assembly 120 can also be referred to as a feed-plate, as this can be where fluids such as reactant(s) and or coolant are supplied to and discharged from the fuel cell stack 100 through the feed-plate, via fluid connections (not visible in FIG. 1) to the various fluid inlet and outlet headers in the stack.

In the embodiment shown, each fuel cell assembly has six openings (or ports) 150a, 150b, 150c, 160a, 160b and 160c extending through the thickness of the assembly. Herein, these are referred to as fluid ports. In fuel cell stack 100 each of these six ports aligns with corresponding ports in the adjacent fuel cell assemblies to form six fluid headers extending through fuel cell stack 100 in a direction perpendicular to the plane of the individual fuel cell assemblies. In the embodiment shown, these headers are used for the supply and discharge of fluids. For example, in a co-flow configuration (where fuel, oxidant and coolant are directed across fuel cell assemblies 110 in substantially the same direction) ports 150a can form a fuel inlet header, and ports 160a can form a fuel outlet header, these headers fluidly connected to each other via fuel flow fields on the anode side of fuel cell assemblies 110. For example, in some embodiments anode flow fields can include a plurality of fuel channels, such as channels 115 shown in FIG. 1. Similarly, ports 150b can form an oxidant inlet header, and ports 160b can form an oxidant outlet header, these headers fluidly connected to each other via oxidant flow fields on the cathode side of fuel cell assemblies 110. In some embodiments, ports 150c can form a coolant inlet header, and ports 160c can form a coolant outlet header, these headers fluidly connected to each other via coolant flow fields in fuel cell assemblies 110. Thus, a flow field provides a fluid connection between an inlet port and a corresponding outlet port in a fuel cell plate, and between an inlet header and corresponding outlet header in a fuel cell assembly. A flow field can include one or more channels formed in a plate, pathways through porous media, interconnected pores, an open chamber or plenum, and the like.

In some embodiments, other flow configurations can be used. For example, in some embodiments, the fuel and oxidant can be directed in a counter-flow configuration where they flow in substantially opposite directions across the fuel cell assemblies. For example, fuel cell stack 100 in FIG. 1 can be configured and connected so that ports 150a are fuel inlet ports and 160a are fuel outlet ports, and ports 160b are oxidant inlet ports and 150b are oxidant outlet ports. In some fuel cell stacks, the fuel and oxidant can be directed in a cross-flow configuration, or some other configuration or combination of configurations. Similarly various configurations of coolant flow relative to the fuel and oxidant flow directions can be used.

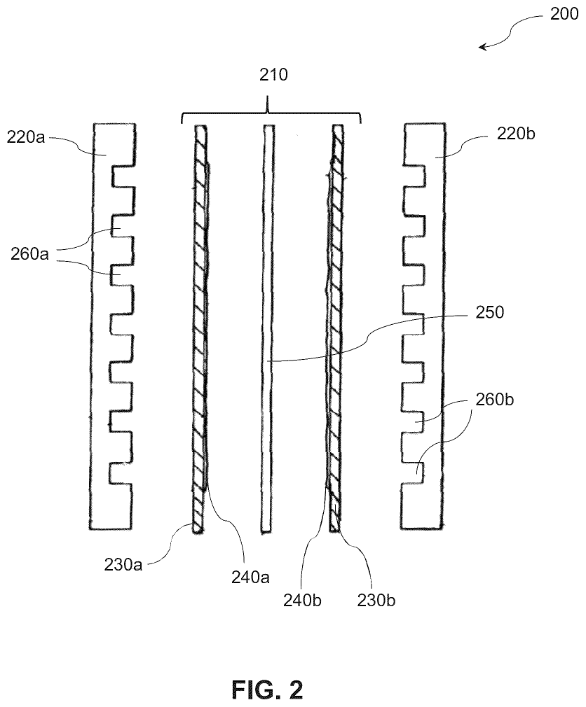

FIG. 2 shows a simplified exploded cross-sectional view of an example of individual fuel cell 200 with membrane electrode assembly (MEA) 210 interposed between a pair of flow field plates 220a and 220b. MEA 210 comprises a membrane-electrolyte sandwich, with membrane electrolyte 250 and gas diffusion layer (GDL) 230a on the anode side with anode catalyst layer 240a interposed between GDL 230a and membrane 250, and another GDL 230b on the cathode side with cathode catalyst layer 240b interposed between GDL 230b and membrane 250. In some methods of manufacturing a fuel cell, the catalyst layers are deposited on the membrane. In some methods of manufacturing a fuel cell, the catalyst layers are deposited on the GDL. Flow field plates 220a and 220b have channel 260a and channel 260b, respectively formed therein, for directing fuel and oxidant to the respective GDL and catalyst layers.

In many fuel cells and fuel cell stacks, coolant channels are provided for delivery or circulation of a coolant fluid such as water or air for thermal management of the operating fuel cell or fuel cell stack. In some embodiments, coolant channels can be provided on the back of the anode or cathode flow field plates (in other words, on the opposite face to the reactant channels), and/or in separate coolant flow field plates interposed between adjacent fuel cells in a stack.

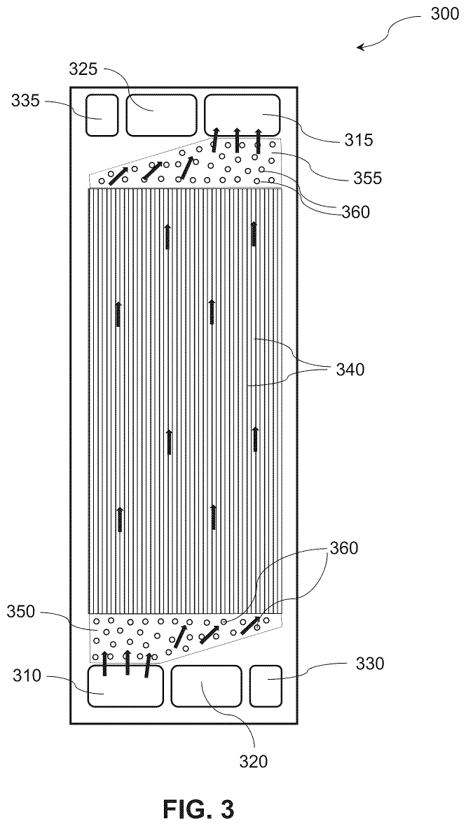

FIG. 3 is a plan view of an example of fuel cell flow field plate 300. Flow field plate 300 includes oxidant inlet port 310, oxidant outlet port 315, coolant inlet port 320, coolant outlet port 325, fuel inlet port 330 and fuel outlet port 335. A plurality of oxidant channels 340 extend across a central region of flow field plate 300. In flow field plate 300, the oxidant flow field includes oxidant inlet transition region 350, channels 340, and oxidant outlet transition region 355. In the illustrated example the inlet ports 310, 320 and 330 are located along the opposite side of the plate from the corresponding outlet ports 315, 325 and 335, and none of the ports spans the entire width of the flow field area containing oxidant channels 340. When flow field plate 300 is layered with other plates and fuel cell components (e.g. MEAs) in a fuel cell stack, oxidant flows from oxidant inlet port 310 to oxidant channels 340 via an oxidant inlet transition region 350, through channels 340 in the direction of the arrows, and then via an oxidant outlet transition region 355 to oxidant outlet port 315. A similar flow field arrangement can be used on the underside of flow field plate 300 for the fuel. In some embodiments, transition regions 350 and 355 can include pillars 360 or other suitable flow features to direct and distribute the oxidant flow between oxidant inlet port 310 and among channels 340, and to direct flow between channels 340 and oxidant outlet port 315, and to support the adjacent MEA. In the illustrated embodiment of flow field plate 300, transition regions 350 and 355 occupy a significant portion of the overall area of flow field plate 300. They also occupy a significant area relative to the area of all six ports combined, and/or relative to the fuel cell active area (which, depending on the location of electrocatalyst in the MEA that is used with the plate, can be just the area occupied by oxidant channels 340 and the landing areas between them or can also include the area of transition region 350 and/or 355. If both transition regions 350 and 355 are included, the active area is the same as the area occupied by the oxidant flow field).

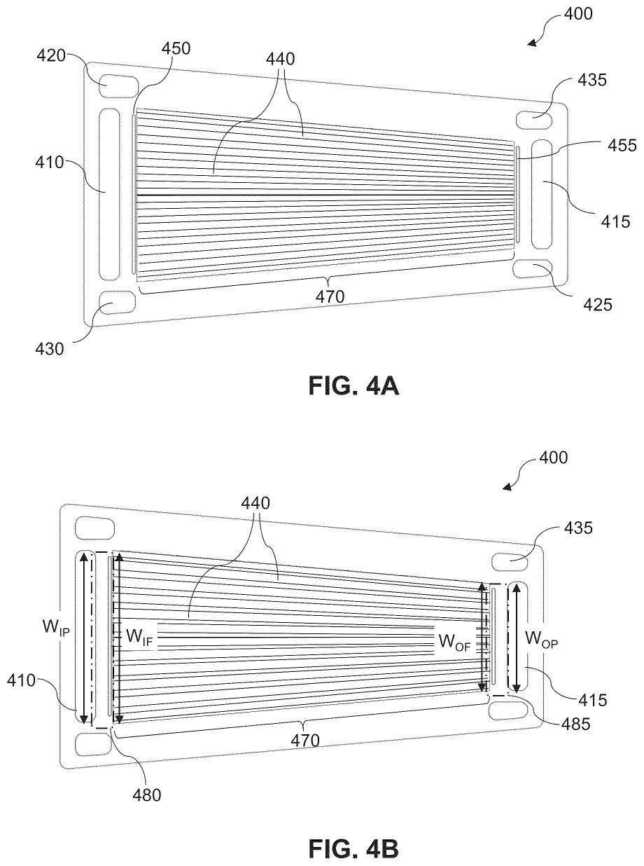

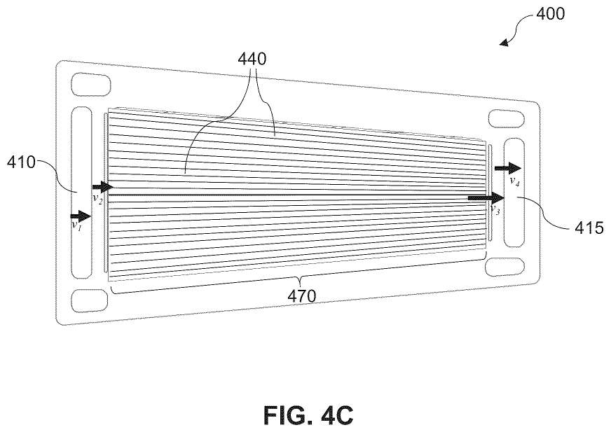

FIG. 4A shows trapezoidal fuel cell flow field plate 400. Fuel cell flow field plate 400 includes oxidant inlet port 410, oxidant outlet port 415, coolant inlet port 420, coolant outlet port 425, fuel inlet port 430, fuel outlet port 435 and oxidant channels 440 extending across active area 470 of fuel cell flow field plate 400. In this embodiment, active area 470 occupies substantially the same area as the oxidant flow field. With this arrangement of ports, the plate can be configured for co-flow of oxidant, coolant and fuel, for example. In the illustrated embodiment of fuel cell flow field plate 400, oxidant inlet port 410 spans the width of one end of active area 470 at the start of oxidant channels 440, and oxidant outlet port 415 spans the width of the opposite end of active area 470 at the end of oxidant channels 440. In at least some embodiments, fuel inlet port 430, fuel outlet port 435, coolant inlet port 420, and coolant outlet port 425 are “offset” relative to active area 470. In at least some embodiments, when fuel cell flow field plate 400 is layered with other plates and fuel cell components (e.g. MEAs) in a fuel cell stack, oxidant flows from oxidant inlet port 410 (which forms part of the oxidant supply header) to oxidant channels 440 via a plenum and/or channels (not visible in FIG. 4A) on the underside of plate 400, then through oxidant inlet slot 450 (which is another opening formed in plate 400) and into the inlets of channels 440. In at least some embodiments, at the opposite end of oxidant channels 440, the remaining oxidant exits the channels, passes though oxidant outlet slot 455 to the underside of plate 400 and via a plenum and/or channels (not visible in FIG. 4A) into oxidant outlet port 415 (which forms part of the oxidant exhaust header).

In the embodiment shown in FIG. 4A, flow field plate 400 has oxidant channels 440 that decrease width along their length from inlet to outlet. In some embodiments the oxidant channels decrease in cross-sectional area along some or all of their length. In some embodiments the oxidant channels decrease linearly in cross-sectional area along some or all of their length. In some embodiments the oxidant channels decrease exponentially in cross-sectional area along some or all of their length. In some embodiments the oxidant channels decrease linearly in width along some or all of their length. In some embodiments the oxidant channels decrease exponentially in width along some or all of their length. In some embodiments the oxidant channels decrease monotonically in cross-sectional area along their length. In some embodiments the oxidant channels decrease monotonically in width along their length.

Similarly, the fuel channels on the anode flow field plate (which can be a bipolar plate with oxidant channels on one side and cathode channels on the other side) can have fuel channels with cross-sectional area or width that decreases along at least a portion of their length. In some embodiments the fuel channels decrease monotonically in cross-sectional area along their length. In some embodiments the fuel channels decrease monotonically in width along their length.

In at least some embodiments, fuel cells having flow field plates with reactant channels having cross-sectional areas that vary along at least a portion of the channel length between an inlet and an outlet operate with more uniform current density distribution than fuel cells with conventional flow field plates with reactant channels that have substantially constant cross-sectional area along their length.

In at least some embodiments, this more uniform current density distribution reduces the occurrence of hot zones in the inlet region of the fuel cell active area, and therefore reduces the need for enhanced cooling in this region. Hot zones are common in conventional fuel cells with conventional flow fields (i.e. those with channels having substantially constant cross-sectional area along their length) where oxygen concentrations are highest. In some embodiments, this allows the oxidant inlet port to be aligned and matched to the width of the active area at the inlet end of the oxidant channels. Correspondingly, in some embodiments the oxidant outlet port can also be aligned and matched with the width of the active area at the outlet end of the oxidant channels, as in the embodiment illustrated in FIG. 4A, for example. In some embodiments, such as shown in FIG. 4A, this allows for the coolant inlet and outlet ports and/or the fuel inlet and outlet ports to be offset from the cathode inlet and outlet ports, on either side of the active area, for example, thereby reducing or eliminating the need for a transition region in the cathode inlet region (where it is most often needed) and also in the cathode outlet region. In some embodiments, coolant channels follow a Z-type flow configuration. In some embodiments, fuel channels follow a Z-type flow configuration. Achieving uniform flow distribution of the fuel among the fuel channels at the anode is generally less critical than achieving uniform, or at least near uniform, flow distribution of oxidant among the oxidant channels at the cathode. This can be particularly true when the fuel is substantially pure hydrogen, and the oxidant is air. This is because the fuel is more concentrated and because of its properties (e.g. viscosity and density) hydrogen can access the electrocatalysts sites more easily. In contrast the oxidant is usually air, which is a dilute oxygen stream.

In some embodiments of fuel cell assemblies and fuel cell flow field plates, placement of the cathode port allows oxidant flow targets to be met by optimization of the various slots and ports. An inlet slot (or other tunnel or opening) extending through the thickness of the plate can be used to connect reactant flow that can originate from the backside of the plate before entering the channels on the primary surface of the plate where the channels for that particular reactant are located, and an outlet slot can be used to direct reactant flow exiting channels on the primary surface of the plate through to the backside of the plate. In some embodiments this reduces, if not eliminates, the need for a transition region. In the case of the cathode, the inlet slot and port can span the width of the majority, if not all, of the inlets to the reactant channels. In at least some embodiments, the flow can be uniformly, or at least near uniformly, distributed across the width of the flow field. In such embodiments, this can create a uniform or nearly uniform flow distribution among the reactant channels.

Some embodiments of fuel cell assemblies and fuel cell flow field plates described herein can be used to achieve fluid flow distribution among channels for a particular fluid (for example, oxidant) where the flow rate in all of the channels for that fluid is within ±20% of the average flow rate among the channels. Some embodiments of fuel cell assemblies and fuel cell flow field plates can be used to achieve fluid flow distribution among channels for a particular fluid where the flow rate in all of the channels for that fluid is within ±15% of the average flow rate among the channels. Some embodiments of fuel cell assemblies and fuel cell flow field plates can be used to achieve fluid flow distribution among channels for a particular fluid where the flow rate in all of the channels for that fluid is within ±10% of the average flow rate among the channels. Some embodiments of fuel cell assemblies and fuel cell flow field plates can be used to achieve fluid flow distribution among channels for a particular fluid where the flow rate in all of the channels for that fluid is within ±2.5% of the average flow rate among the channels.

Some embodiments of fuel cell assemblies and fuel cell flow field plates described herein can be used to achieve fluid flow distribution among channels for a particular fluid (for example, oxidant) where the flow rate in at least 90% of the channels for that fluid is within ±20% of the average flow rate among the channels. Some embodiments of fuel cell assemblies and fuel cell flow field plates can be used to achieve fluid flow distribution among channels for a particular fluid where the flow rate in at least 90% of the channels for that fluid is within ±15% of the average flow rate among the channels. Some embodiments of fuel cell assemblies and fuel cell flow field plates can be used to achieve fluid flow distribution among channels for a particular fluid where the flow rate in at least 90% of the channels for that fluid is within ±10% of the average flow rate among the channels. Some embodiments of fuel cell assemblies and fuel cell flow field plates can be used to achieve fluid flow distribution among channels for a particular fluid where the flow rate in at least 90% of the channels for that fluid is within ±2.5% of the average flow rate among the channels.

In some embodiments of fuel cell assemblies and fuel cell flow field plates, such as in flow field plate 400 shown in FIG. 4A and again in FIG. 4B, the oxidant inlet port width (W_{IP}) is substantially the same as the oxidant inlet flow field width (W_{IF}). In some embodiments, the width of the oxidant inlet port and the width of oxidant flow field inlet differ by no more than 25% of the width of the oxidant flow field inlet. In some embodiments, the distribution of oxidant gas (so that it can be supplied more evenly among the channels) occurs primarily in the oxidant inlet port instead of on the surface of the flow field plate, avoiding the need for a region of the plate to be dedicated to this function. In at least some embodiments, the oxidant pressure distribution remains relatively constant among the oxidant channels at perpendicular sections taken down the length of the channels, such the channels experience a relatively consistent pressure drop.

Some embodiments of fuel cell assemblies and fuel cell flow field plates can be used to achieve pressure distribution among channels for a particular fluid where the pressure distribution in all of the channels for that fluid is within ±20% of the average pressure distribution among the channels. Some embodiments of fuel cell assemblies and fuel cell flow field plates can be used to achieve pressure distribution among channels for a particular fluid where the pressure distribution in all of the channels for that fluid is within ±15% of the average pressure distribution among the channels. Some embodiments of fuel cell assemblies and fuel cell flow field plates can be used to achieve pressure distribution among channels for a particular fluid where the pressure distribution in all of the channels for that fluid is within ±10% of the average pressure distribution among the channels. Some embodiments of fuel cell assemblies and fuel cell flow field plates can be used to achieve pressure distribution among channels for a particular fluid where the pressure distribution in all of the channels for that fluid is within ±1% of the average pressure distribution among the channels.

Some embodiments of fuel cell assemblies and fuel cell flow field plates can be used to achieve pressure distribution among channels for a particular fluid where the pressure distribution in at least 90% of the channels for that fluid is within ±20% of the average pressure distribution among the channels. Some embodiments of fuel cell assemblies and fuel cell flow field plates can be used to achieve pressure distribution among channels for a particular fluid where the pressure distribution in at least 90% of the channels for that fluid is within ±15% of the average pressure distribution among the channels. Some embodiments of fuel cell assemblies and fuel cell flow field plates can be used to achieve pressure distribution among channels for a particular fluid where the pressure distribution in at least 90% of the channels for that fluid is within ±10% of the average pressure distribution among the channels. Some embodiments of fuel cell assemblies and fuel cell flow field plates can be used to achieve pressure distribution among channels for a particular fluid where the pressure distribution in at least 90% of the channels for that fluid is within ±1% of the average pressure distribution among the channels.

In some embodiments of fuel cell assemblies and fuel cell flow field plates, such as in flow field plate 400 shown in FIG. 4A and FIG. 4B, the oxidant outlet port width (W_{OP}) is substantially the same as the oxidant outlet flow field width (W_{OF}). In some embodiments, the width of the oxidant outlet port and the width of oxidant flow field outlet differ by no more than 25% of the width of the oxidant flow field outlet.

In some embodiments, placement of the oxidant inlet port directly upstream of the majority of the oxidant channels increases fuel cell stack power density, reduces flow shorting, improves oxidant distribution among the channels and/or improves the capacity for water removal when compared to flow field plates and fuel cell assemblies with a transition region between the oxidant inlet port and oxidant channels.

In some embodiments of fuel cell assemblies and fuel cell flow field plates, there is still a transition region between the oxidant inlet port and the oxidant channels and/or between the oxidant channels and the oxidant outlet port, but the width of each transition region (or the overall cross-sectional flow area of the transition region) does not vary much in the flow direction between its inlet and outlet. For example, FIG. 4B illustrates fuel cell flow field plate 400 (of FIG. 4A) with inlet transition region 480 and outlet transition region 485 indicated with dot-dash lines. These transition regions occupy a relatively small area of flow field plate 400. The width of each transition region 480 and 485 does not vary substantially from its inlet to outlet, unlike for transition regions 350 and 355 in FIG. 3, where transition region 350 widens to distribute oxidant from oxidant inlet port 310 to channels 340 and where transition region 355 collects oxidant from channels 340 and narrows to direct it to oxidant outlet port 315. Because the width of each of transition regions 480 and 485 does not vary substantially from its inlet to outlet, these transition regions will not cause a significant change in velocity of a fluid flowing through them.

In some embodiments of fuel cell assemblies and fuel cell flow field plates, for at least the oxidant, and optionally for the fuel and/or coolant as well (individually and/or in combination): the area of the inlet transition region plus the outlet transition region makes up less than 20% percent of the total area of the fuel cell active area (which in some embodiments includes the transition regions, and in some embodiments does not), and/or makes up less than 20% of the area occupied by the respective flow field (which include the transition regions). In some preferred embodiments, the area of the inlet transition region plus the outlet transition region makes up less than 15% of the total area of the fuel cell active area, and/or makes up less than 15% of the area occupied by the respective flow field. In some more preferred embodiments, the area of the inlet transition region plus the outlet transition region makes up less than 10% of the total area of the active area, and/or makes up less than 10% of the area occupied by the respective flow field. In some even more preferred embodiments, the area of the inlet transition region plus the outlet transition region makes up less than 7.5% of the area of the total of the active area, and/or makes up less than 7.5% of the area occupied by the respective flow field. In some embodiments the area occupied by the flow field is substantially the same as the active area (for example, where the transition regions are included in the active area because they overlay electrocatalyst). In some embodiments the area occupied by the flow field is greater than the active area.

In some embodiments of fuel cell assemblies and fuel cell flow field plates, the total transition region area for oxidant (i.e. area of the oxidant inlet transition region plus the area of the oxidant outlet transition region) is less than 150% of the total oxidant port area (inlet port area plus the outlet port area). For example, referring to the embodiment of a flow field plate 400 illustrated in FIG. 4B, the combined area of transition regions 480 and 485 would be less than 150% of the combined area of ports 410 and 415. In some preferred embodiments, the total oxidant transition region area is less than 100% of the total oxidant port area. In some other preferred embodiments, the total oxidant transition region area is less than 75% of the total oxidant port area.

In some embodiments of fuel cell assemblies and fuel cell flow field plates, the total transition region area for fuel (i.e. area of the fuel inlet transition region plus the area of the fuel outlet transition region) is less than 150% of the total fuel port area (inlet port area plus the outlet port area). In some preferred embodiments, the total fuel transition region area is less than 100% of the total fuel port area. In some other preferred embodiments, the total fuel transition region area is less than 75% of the total fuel port area.

In some embodiments of fuel cell assemblies and fuel cell flow field plates, the total transition region area for both reactants (i.e. combined area of the fuel and oxidant inlet transition regions and the fuel and oxidant outlet transition regions) is less than 150% of the total reactant port area (inlet port areas plus the outlet port areas). In some preferred embodiments, the total reactant transition region area is less than 100% of the total reactant port area. In some other preferred embodiments, the total reactant transition region area is less than 75% of the total reactant port area.

In some embodiments of fuel cell assemblies and fuel cell flow field plates, the total transition region area for all three fluids (oxidant, fuel and coolant) is less than 150% of the total port area (all inlet port areas plus all outlet port areas). In some preferred embodiments, the total transition region area is less than 100% of the total port area. In some other preferred embodiments, the total transition region area is less than 75% of the total port area.

In some embodiments, a fuel cell flow field plate does not include a transition region between the oxidant inlet port and the oxidant channels and/or between the oxidant channels and the oxidant outlet port. In some embodiments, a fuel cell flow field plate does not include a transition region between the fuel inlet port and the fuel channels and/or between the fuel channels and the fuel outlet port. In some embodiments, a fuel cell flow field plate does not include a transition region between the coolant inlet port and the coolant channels and/or between the coolant channels and the coolant outlet port. In at least some of these embodiments, the inlets and outlets to the channels are located at the respective inlet and outlet ports.

In some embodiments of fuel cell assemblies and fuel cell flow field plates, for at least the oxidant, and optionally for the fuel and/or coolant as well: there is no region on the flow field plate where the cross-sectional flow area expands in the flow direction.

FIG. 4C illustrates fuel cell flow field plate 400 (of FIG. 4A) with various velocity vectors added to indicate the velocity of a fluid (such as oxidant) across the plate when the plate is employed in an operating fuel cell assembly such as a fuel cell stack. V₁ represents the velocity at oxidant inlet port 410. V₂ represents the velocity at the inlet to oxidant channels 440. V₃ represents the velocity at the outlet of oxidant channels 440. V₄ represents the velocity at oxidant outlet port 415. In some embodiments of such a fuel cell assembly, V₁ is roughly equal to V₂. In some embodiments, V₁ and V₂ differ by no more than 30% of V₂. In some embodiments, V₃ is roughly equal to V₄. In some embodiments, V₃ and V₄ differ by no more than 30% of V₄. In some embodiments, V₃ is greater than V₂. In some preferred embodiments, V₃ is greater than V₂ by at least 40% of V₂. In some other preferred embodiments, V₃ is greater than V₂ by at least 100% of V₂. In some other preferred embodiments, V₃ is greater than V₂ by at least 200% of V₂.

In some embodiments, transition regions on flow field plates are designed to reduce, if not minimize, channel-to-channel flow non-uniformity for a given fluid flow. In at least some embodiments, removing the transition region from the plate and providing suitable fluid distribution to the fluid channels directly from the upstream port and/or stack manifold enables the same plate design to be used across a wide range of flow or power conditions. In some embodiments, alternative conditions can be optimized, or at least improved, by changes to a feed or fluid distribution/collection plate and/or inlet or outlet flanges that connect to or are part of the distribution/collection plate.

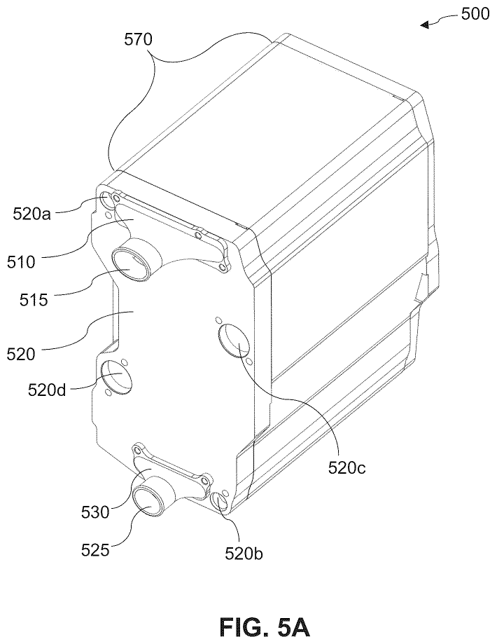

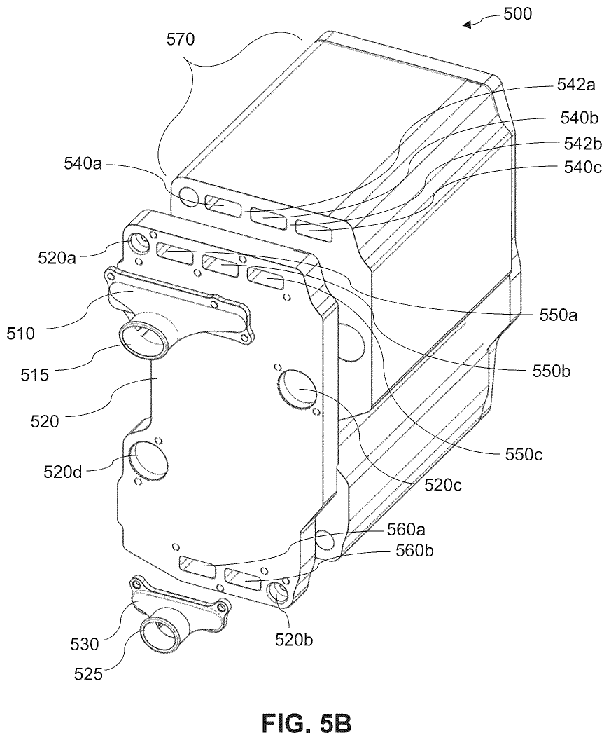

FIG. 5A shows fuel cell stack 500 comprising a plurality of fuel cell assemblies stacked in portion 570. In some embodiments, fuel cell stack 500 includes sculpted (meaning shaped or flared) cathode inlet connector 510, sculpted cathode outlet connector 530, and feed-plate 520. In at least some embodiments, feed-plate 520 includes ports or openings 520a and 520b for connecting fuel supply and exhaust connectors/conduits, respectively, and ports or openings 520c and 520d for connecting coolant supply and exhaust connectors/conduits, respectively. In some embodiments one or more of the openings in the feed-plate are sculpted. In at least some embodiments, sculpted cathode inlet connector 510 provides a substantially uniform distribution of flow (via feed-plate 520) across the width of the oxidant inlet header(s) in the stack (that is made up of the stacked oxidant inlet ports) upstream of the oxidant channels, thereby eliminating, or at least reducing, the need to have a transition region on each of the oxidant flow field plates to distribute the flow among the plurality of oxidant channels. In some embodiments the dimensions, or at least the width of the inlet connector approximately matches the width of the header(s) which it is supplying (see FIG. 5B). In at least some embodiments, sculpted cathode inlet connector 510 and sculpted cathode outlet connector 530 act as transition regions between the oxidant inlet and outlet headers inside the stack and narrower oxidant supply and exhaust conduits 515 and 525, respectively.

FIG. 5B is an exploded perspective view of the fuel cell stack of FIG. 5A, showing that the oxidant inlet header in the fuel cell stack 500 is split into three side-by-side oxidant supply sub-headers 540a, 540b and 540c, that are supplied with oxidant via sculpted cathode inlet connector 510 and corresponding openings 550a, 550b and 550c in feed-plate 520. Oxidant outlet header in fuel cell stack 500 is split into two oxidant exhaust sub-headers (not visible in FIG. 5A or FIG. 5B) which discharge into sculpted cathode outlet connector 530 via corresponding openings 560a and 560b in feed-plate 520. In some embodiments (for example, as shown in FIGS. 5A and 5B), inlet and outlet headers may be split into two or more sub-headers, for example, so that the flow field plates are less fragile around the perimeter of the port(s), as for a wide port there would tend to be a long unsupported span of plate material. In the embodiment illustrated in FIG. 5B, oxidant supply sub-headers 540a, 540b and 540c are formed by aligned openings or ports in the stacked fuel cell flow field plates and membrane electrode assemblies (MEAs). The three openings in the fuel cell flow field plates (corresponding to oxidant supply sub-headers 540a, 540b and 540c) are separated by support bridge portions 542a and 542b. In some embodiments, the thickness of these support bridge portions is less than the thickness of other portions of the flow field plate, so that when the plates and MEAs are stacked, fluid can pass between sub-headers. Similarly, outlet sub-headers in a fuel cell stack can be fluidly connected to one another via support bridge portions that are not as thick as the rest of the flow field plate.

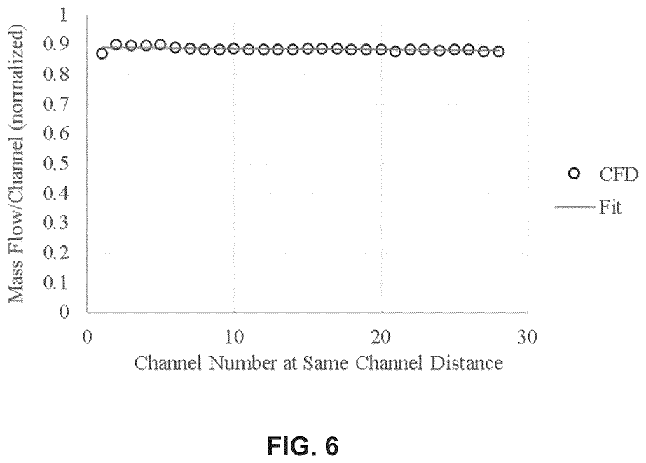

FIG. 6 is a plot showing the mass flow rate in each channel of a plurality of channels in a flow field, determined at the same distance from the inlet of each channel. The results are derived from a computational fluid dynamics (CFD) simulation of typical operating conditions for a trapezoidal cathode plate, similar to that shown in FIGS. 4A-C, in which the area of the inlet transition region plus the outlet transition region makes up approximately 9% of the area of the total of the active area, and in which the flow field comprises a plurality of oxidant channels that decrease exponentially in width along >90% of their length. The results show that the channel-to-channel variation in flow rate is about 3% based on the average mass flow rate, and when a best-fit linear line is applied to the data points, the variation is 1%.

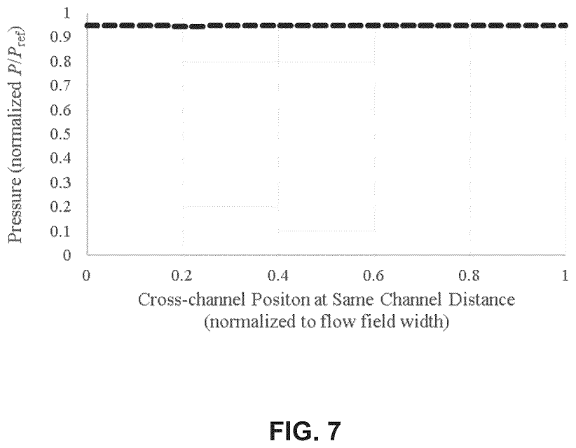

FIG. 7 is a plot showing the pressure in each channel of a plurality of channels in a flow field, determined at the same distance from the inlet of each channel. The results are derived from a CFD simulation of typical operating conditions for a trapezoidal cathode plate (like that used for the simulation of FIG. 6), in which the area of the inlet transition region plus the outlet transition region makes up approximately 9% of the area of the total of the active area, and in which the flow field comprises a plurality of oxidant channels that decrease exponentially in width along >90% of their length. The results show that the channel-to-channel variation in pressure is less than 1% based on the average pressure.

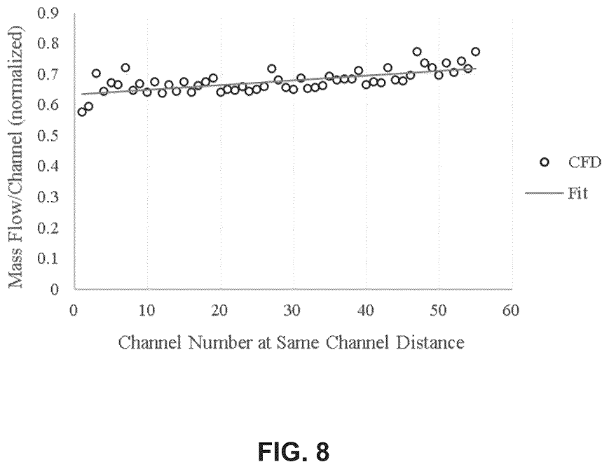

FIG. 8 is a plot showing the mass flow rate in each channel of a plurality of channels in a flow field, determined at the same distance from the inlet of each channel. The results are derived from a CFD simulation of typical operating conditions for a trapezoidal anode flow field plate in which the area of the inlet transition region plus the outlet transition region makes up approximately 4% of the area of the total of the active area, and in which the flow field comprises a plurality of fuel channels that have constant cross-sectional area along a first portion of their length and decrease exponentially in width along a second portion of their length, the second portion being about 60% of their length. In the plate used for this simulation, the plurality of fuel channels are connected to a corner anode inlet port (like port 430 in FIG. 4A) via an anode inlet slot, and connected to a corner anode outlet port (like port 435 in FIG. 4A) via an anode outlet slot. The results show that the channel-to-channel variation in flow rate is about 29% based on the average mass flow rate, and when a best-fit linear line is applied to the data points, the variation is 12%.

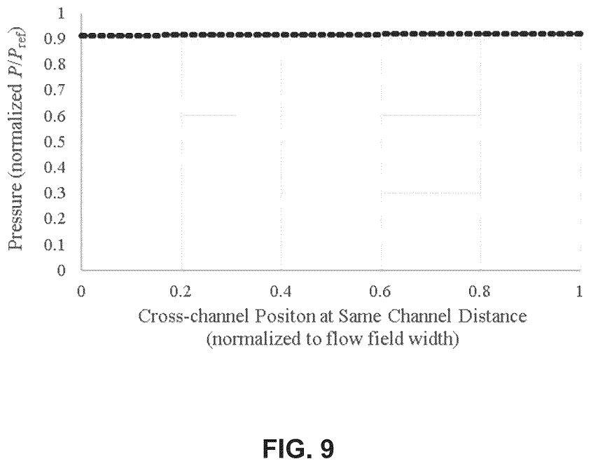

FIG. 9 is a plot showing the pressure in each channel of a plurality of channels in a flow field, determined at the same distance from the inlet of each channel. The results are derived from a CFD simulation of typical operating conditions of a trapezoidal anode flow field plate (like that used for the simulation of FIG. 8) in which the area of the inlet transition region plus the outlet transition region makes up approximately 4% of the area of the total of the active area, and in which the flow field comprises a plurality of fuel channels that have constant cross-sectional area along a first portion of their length and decrease exponentially in width along a second portion of their length, the second portion being about 60% of their length. The results show that the channel-to-channel variation in pressure is less than 1% based on the average pressure.

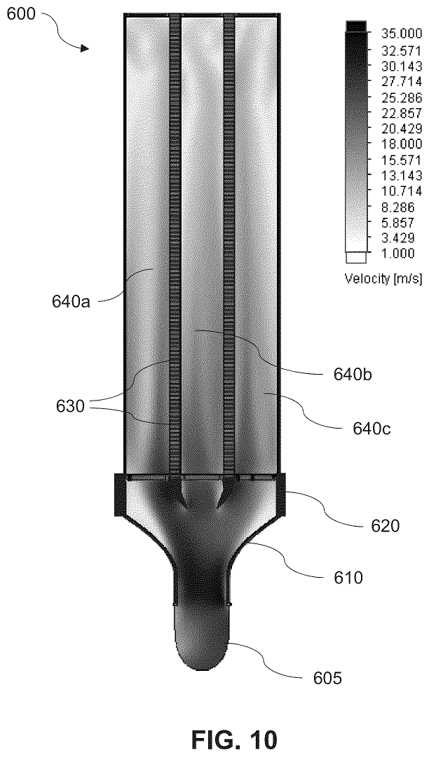

FIG. 10 illustrates a fuel cell stack 600 showing the velocity of fluid flow from oxidant inlet conduit 605, through sculpted oxidant inlet connector 610 and feed-plate 620, and then through three parallel inlet sub-headers 640a, 640b and 640c (which together form an inlet header) in fuel cell stack 600, based on CFD modelling.

Each of the fuel cell flow field plates 630 in the stack has three oxidant inlet ports (not shown in FIG. 10) located side-by-side along one side of the plate, and the ports in the stacked plates align to form sub-headers 640a, 640b and 640c extending through stack 600 along its length (similar to the oxidant supply sub-headers 540a, 540b and 540c in FIG. 5B). The sculpting and lofting of the inner surface of oxidant inlet connector 610, and the configuration of the openings in feed-plate 620, help distribute the fluid flow more evenly among the three sub-headers 640a, 640b and 640c. For example, central vanes or louvers can be used to deflect fluid away from the central sub-header, distributing the fluid more evenly; the cross-sectional flow area through the supply openings in the feed-plate can increase in the flow direction, for example in a monotonic and smooth fashion; the inner walls of the inlet connector can have a continuous curvature, again with the cross-sectional flow area increasing in the flow direction, etc. At least in part due to the sculpting of the inlet connector and end-plate supply openings, at any cross-section taken perpendicular to the primary direction of flow down the length of the stack, the velocity in each of the three sub-headers is within 20% of the average flow velocity in any of the sub-headers taken at that cross-section, so that the supply to the oxidant channels on each plate is fairly consistent from each of the three sub-headers.

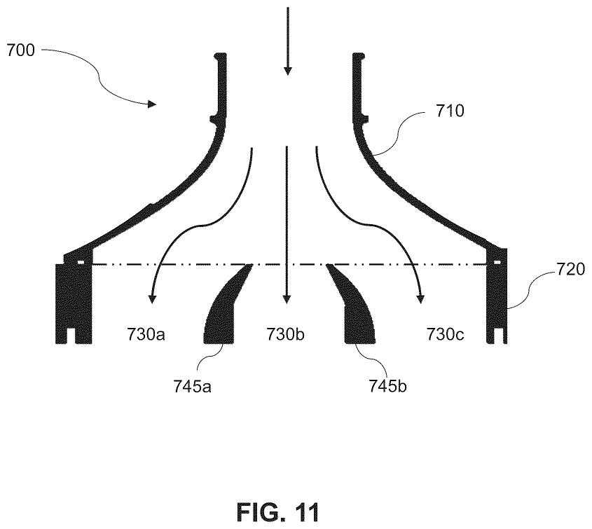

FIG. 11 illustrates details of the combined features of an oxidant inlet assembly 700 for a fuel cell stack (not shown in FIG. 11). FIG. 11 shows (in cross-section) sculpted oxidant inlet connector 710 and sculpted features of feed-plate 720 used to achieve a balanced distribution of oxidant fluid flow to three downstream supply sub-headers in a fuel cell stack (not shown in FIG. 11, but for example, like fuel cell stack 500 of FIG. 5A and FIG. 5B) via left inlet header opening 730a, center inlet header opening 730b and right inlet header opening 730c, formed between inlet louvers 745a and 745b. In the oxidant flow path through oxidant inlet connector 710 and feed-plate 720, there is no appreciable expansion in cross-sectional flow area in the flow direction (which would tend to cause a reduction in flow velocity). In at least some embodiments, feed-plate 720 is configured such that the cross-sectional flow area at the opening of center inlet header opening 730b is less than the cross-sectional flow area at left and right inlet header openings 730a and 730c, respectfully.

In at least some embodiments, the combination of sculpted oxidant inlet connector 710 and the sculpted features of feed-plate 720 (including inlet louvers, such as 745a and 745b, for example) evenly distributes the oxidant fluid to the three sub-headers to provide a substantially even mass flow rate, without any appreciable reduction in flow velocity occurring the flow direction and/or pressure drop. In at least some embodiments, including inlet louvers (such as 745a and 745b) redirects the flow from favoring center inlet header opening 730b to ensure all three header openings achieve targeted flow distribution.

In some embodiments, an inlet opening in a feed-plate has one inlet louver. In some embodiments, the inlet opening in a feed-plate has multiple inlet louvers. In some embodiments, the inlet louvers are similar in shape. In some embodiments, the inlet louvers have various shapes. In some embodiments, the surface of at least one inlet louver is smooth. In some embodiments, the surface of at least one inlet louver is textured with grooves. In at least some embodiments, inlet louvers provide physical support to feed-plate 720. Similarly, sculpting, louvres and other features can be used at the outlet, for example, in discharge openings in a feed-plate and/or in an outlet connector.

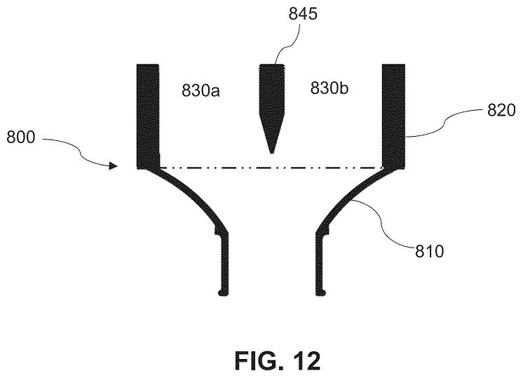

FIG. 12 illustrates details of the combined features for an oxidant outlet assembly 800 for a fuel cell stack (not shown in FIG. 12). FIG. 12 shows (in cross-section) sculpted features in feed-plate 820 and in sculpted oxidant outlet connector 810 used collect oxidant fluid exiting the fuel cell assemblies in a fuel cell stack. The oxidant fluid from flow field plates in the fuel cell stack passes through feed-plate 820 and into sculpted oxidant outlet connector 810, with no appreciable expansion in cross-sectional flow area in the flow direction (which would tend to cause a reduction in flow velocity). In some embodiments, feed-plate 820 has a single outlet louver 845 at the oxidant outlet. In some embodiments, outlet louver separates feed-plate into outlet header opening 830a and outlet header opening 830b.

In some embodiments the width of the inlet header(s) and corresponding inlet connector is substantially the same as the width of the outlet header(s) and corresponding outlet connector. In some embodiments the width of the inlet header(s) and corresponding inlet connector different from the width of the outlet header(s) and corresponding outlet connector. In the fuel cell stack illustrated in FIGS. 5A and 5B and in the inlet and outlet assemblies illustrated in FIGS. 11 and 12, the width of the oxidant inlet header(s) and corresponding inlet connector is greater than the width of the oxidant outlet header(s) and corresponding outlet connector. This is because, in these embodiments, the flow field plates are trapezoidal and the cathode flow field is wider at the inlet than at the outlet.

In some embodiments, a feed-plate has multiple outlet louvers. In some embodiments, the surface of outlet louver 845 is smooth. In some embodiments, the surface of outlet louver 845 is textured with grooves. In at least some embodiments, the outlet louver(s) provide physical support to feed-plate 820.

In at least some embodiments, at least one outlet louver of the feed-plate enables fluids to flow from the two outlet sub-headers to the outlet connector and exit the stack without experiencing an expansion in cross-sectional flow area that would result in a loss of velocity.

In some embodiments, one or more inserts, vanes, louvers, baffles, and/or other suitable flow directing features can be included in a cathode and/or anode inlet connector and/or adjacent feed-plate(s) to aid in providing the desired fluid distribution to the downstream headers and channels in a fuel cell stack. Similarly, one or more inserts and/or flow directing features can be included in a cathode and/or anode outlet connector and/or adjacent feed-plate(s).

As discussed, reducing the area of (or eliminating) transition regions on the fuel cell flow field plates, can offer several benefits, including but not limited to, improved power density of a fuel cell stack; more uniform flow distribution; improved water management; and/or allowing greater flexibility in locating ports. Reducing or eliminating one or more of the inlet transition regions from the flow field plate and achieving desired flow distribution across the width of a flow field by the design of the inlet manifolds, connectors and/or feed-plates can also allow for increased flexibility allowing one to optimize or at least increase compatibility for a given set of operating conditions. Similarly at the outlet side, outlet manifolds, connectors and/or feed-plates can be designed to reduce or eliminate one or more of the outlet transition regions from the flow field plates.

Electrolyzers, redox flow batteries, and other through other electrochemical reactors/devices could also benefit from a reduction or elimination of the transition region.

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive sense.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or variants thereof, mean connection or coupling, either direct or indirect, permanent or non-permanent, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a component (e.g. a flow field plate, gas diffusion layer, spring, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which perform the function of the described component.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A fuel cell assembly comprising:
(a) a first flow field plate comprising:
(i) a first inlet port;
(ii) a second inlet port;
(iii) a first outlet port; and
(iv) a second outlet port;
(b) a second flow field plate comprising:
(i) a corresponding first inlet port;
(ii) a corresponding second inlet port;
(iii) a corresponding first outlet port; and
(iv) a corresponding second outlet port; and
(c) a membrane electrode assembly between said first flow field plate and said second flow field plate,
wherein:
said first inlet port and said corresponding first inlet port align to form at least a portion of a first inlet header,
said second inlet port and said corresponding second inlet port align to form at least a portion of a second inlet header,
said first outlet port and said corresponding first outlet port align to form at least a portion of a first outlet header,
said second outlet port and said corresponding second outlet port align to form at least a portion of a second outlet header,
said first inlet port is fluidly connected to said first outlet port via a first flow field wherein said first flow field comprises a first plurality of channels, each channel of said first plurality of channels having a first channel inlet and a first channel outlet;
said second inlet port is fluidly connected to said second outlet port via a second flow field;
said first channel inlets of said first plurality of channels are fluidly connected to said first inlet port via a first inlet transition region; and
said first channel outlets of said first plurality of channels are fluidly connected to said first outlet port via a first outlet transition region.

2. The fuel cell assembly of claim 1, wherein the combined area of said first inlet transition region and said first outlet transition region is less than 150% of the combined area of said first inlet port and said first outlet port.

3. The fuel cell assembly of claim 1, wherein said first flow field occupies a first flow field area, and wherein the combined area of said first inlet transition region and said first outlet transition region is less than 20% of said first flow field area.

4. The fuel cell assembly of claim 1, wherein said first flow field occupies a first flow field area, and wherein the combined area of said first inlet transition region and said first outlet transition region is less than 10% of said first flow field area.

5. The fuel cell assembly of claim 1, wherein a cross-sectional flow area in said first inlet transition region is constant between said first inlet port and said first channel inlets of said first plurality of channels, and/or a cross-sectional flow area in said first outlet transition region is constant between said first channel outlets of said first plurality of channels and said first outlet port.

6. The fuel cell assembly of claim 1, wherein:
said second flow field comprises a second plurality of channels, each channel of said second plurality of channels having a second channel inlet and a second channel outlet,
said second channel inlets of said second plurality of channels are fluidly connected to said second inlet port via a second inlet transition region, and
said second channel outlets of said second plurality of channels are fluidly connected to said second outlet port via a second outlet transition region.

7. The fuel cell assembly of claim 6, wherein the combined area of said first inlet transition region, said first outlet transition region, said second inlet transition region and said second outlet transition region is less than 150% of the combined area of said first inlet port, said first outlet port, said second inlet port and said second outlet port.

8. The fuel cell assembly of claim 6, wherein said first flow field occupies a first flow field area, and the combined area of said first inlet transition region, said first outlet transition region, said second inlet transition region and said second outlet transition region is less than 20% of said first flow field area.

9. The fuel cell assembly of claim 1, wherein
said first inlet port has a first inlet port width and, at said first channel inlets of said first plurality of channels, said first plurality of channels span a first inlet flow field width,
said first outlet port has a first outlet port width and, at said first channel outlets of said first plurality of channels, said first plurality of channels span a first outlet flow field width,
said first inlet flow field width is the same as said first inlet port width, and
said first outlet flow field width is the same as said first outlet port width.

10. The fuel cell assembly of claim 1, wherein:
said first inlet port has a first inlet port width and, at said first channel inlets of said first plurality of channels, said first plurality of channels span a first inlet flow field width,
said first outlet port has a first outlet port width and, at said first channel outlets of said first plurality of channels, said first plurality of channels span a first outlet flow field width,
said first inlet port width and said first inlet flow field width differ by no more than 25% of said first inlet flow field width, and
said first outlet port width and said first outlet flow field width differ by no more than 25% of said first outlet flow field width.

11. The fuel cell assembly of claim 1, wherein said first flow field plate is a cathode flow field plate, and said first inlet port, said first outlet port and said first flow field are configured to carry an oxidant.

12. The fuel cell assembly of claim 1, said fuel cell assembly having an active area, wherein said active area is trapezoidal.

13. The fuel cell assembly of claim 1, wherein said first flow field plate and said second flow field plate are trapezoidal.

14. The fuel cell assembly claim 1, wherein each channel of said first plurality of channels decreases in cross-sectional area along at least a portion of a channel length from said first channel inlet to said first channel outlet.

15. The fuel cell assembly of claim 1, wherein each channel of said first plurality of channels decreases exponentially in cross-sectional area along at least a portion of a channel length from said first channel inlet to said first channel outlet.

16. A fuel cell stack comprising:
(a) the fuel cell assembly of claim 1;
(b) a first end-plate assembly; and
(c) a second end-plate assembly;
(d) disc springs, tie-rods, hydraulic systems, clamps, and/or straps configured to urge said first end-plate assembly and said second end-plate assembly toward each other;
(e) a sculpted first inlet connector fluidly connected to said first inlet header via said first end-plate assembly; and/or
(f) a sculpted first outlet connector fluidly connected to said first outlet header via said second end-plate assembly.

17. The fuel cell stack of claim 16 comprising said sculpted first inlet connector fluidly connected to said first inlet header via said first end-plate assembly, wherein said first end-plate assembly comprises an at least one inlet louvre, and a combination of said sculpted first inlet connector and said at least one inlet louver acts as an upstream transition region for distributing a fluid to said fuel cell assembly.

18. The fuel cell stack of claim 17 wherein said first flow field occupies a first flow field area, and wherein the combined area of said first inlet transition region and said first outlet transition region is less than 20% of said first flow field area.

19. The fuel cell stack of claim 17 wherein said first flow field occupies a first flow field area, and wherein the combined area of said first inlet transition region and said first outlet transition region is less than 10% of said first flow field area.

20. The fuel cell stack of claim 16 comprising said sculpted first outlet connector fluidly connected to said first outlet header via said second end-plate assembly, wherein said second end-plate assembly comprises at least one outlet louvre, and a combination of said sculpted first outlet connector and an at least one outlet louver enables a fluid to be discharged from said fuel cell assembly via said second end-plate assembly and said sculpted first outlet connector without experiencing an expansion in cross-sectional flow area that would result in a reduction in flow velocity of said fluid.
